(19) United States
(12) Patent Application Publication
(10) Pub. No.: US 2021/0034559 A1
(43) Pub. Date: Feb. 4, 2021

(54) Packet Processing Device and Packet Processing Method

(71) Applicant: Nippon Telegraph and Telephone Corporation, Tokyo (JP)

(72) Inventors: Tomoaki Kawamura, Tokyo (JP); Saki Hatta, Tokyo (JP); Shoko Oteru, Tokyo (JP); Koji Yamazaki, Tokyo (JP); Takahiro Hatano, Tokyo (JP)

(21) Appl. No.: 17/046,142

(22) PCT Filed: Mar. 28, 2019
(86) PCT No.: PCT/JP2019/013590

§ 371 Date: Oct. 8, 2020

(30) Foreign Application Priority Data
Apr. 10, 2018 (JP) 2018-075228

(51) Int. Cl. G06F 13/28; G06F 13/16; G06F 12/1081; H04L 12/861

(52) U.S. Cl. CPC G06F 13/28; H04L 49/9047; G06F 12/1081; G06F 13/1668

(57) ABSTRACT

A packet processing device includes: a line adapter configured to receive packets from a communication line; a packet combining unit configured to generate a combined packet by combining a plurality of packets received from the communication line; a packet memory configured to store packets received from the communication line; and a combined packet transferring unit configured to DMA transfer the combined packet generated by the packet combining unit to the packet memory. The combined packet transferring unit writes information of an address of first data of each packet inside the combined packet on the packet memory into a descriptor that is a data area on a memory set in advance.

### CROSS-REFERENCE TO RELATED APPLICATIONS

This application is a national phase entry of PCT Application No. PCT/JP2019/013590, filed on Mar. 28, 2019, which claims priority to Japanese Application No. 2018-075228, filed on Apr. 10, 2018, which applications are hereby incorporated herein by reference.

### TECHNICAL FIELD

The present invention relates to a packet processing device and a packet processing method, and more particularly, to a packet processing device and a packet processing method for performing a packet data transferring process in a communication system.

### BACKGROUND

FIG. 11 is a block diagram illustrating a configuration of a packet processing device in a related art. The packet processing device includes a line adapter 100 that receives packets from a communication line, a packet memory 101 that stores packets received from the communication line, a packet transferring unit 102 that transfers packets received from the communication line to the packet memory 101, a reception processing unit 103 that reads packets from the packet memory 101, and a protocol processing unit 104 that performs protocol processing for packets.

In this packet processing device, with the arrival of a packet at the line adapter 100 connected to a communication line (not illustrated) as a trigger, the packet transferring unit 102 performs data transfer using a direct memory access (DMA), and stores the packet that has arrived in the packet memory 101. At the same time, the packet transferring unit 102 generates a hardware interrupt to notify a processor (not illustrated) of the packet processing device of the reception of a packet and requests to activate the reception processing unit 103.

The packet transferring unit 102 includes a descriptor 1020 that is a data structure built by software executed by the processor of the packet processing device and a DMA controller 1021 that is hardware. FIG. 12 is a diagram illustrating an overview of the descriptor 1020.

The example illustrated in FIG. 12 illustrates a case in which the packet memory 101 stores N packets. In this case, the processor of the packet processing device sets an address and a flag corresponding to each of the N packets in the descriptor 1020. The processor sets start addresses A #1 to A #N used when received packets are written into the packet memory 101 in the descriptor 1020 in advance. Generally, the number of addresses that can be simultaneously set is determined in advance, and the sequence of addresses to be used is also determined.

The processor sets/resets flags AF #1 to AF #N, which indicate whether the set addresses A #1 to A #N are valid, in the descriptor 1020. After setting the addresses A #1 to A #N, when the processor validates the flags AF #1 to AF #N, packets can be written into the packet memory 101.

In addition, in the descriptor 1020, reception completion flags WF #1 to WF #N indicating whether writing of packets into the set addresses A #1 to A #N has been completed, and received data sizes L #1 to L #N indicating packet lengths of packets that have been written to the set addresses A #1 to A #N are set.

FIG. 13 is a flowchart illustrating operations of the DMA controller 1021. First, the DMA controller 1021 initializes a variable n, which indicates the sequence of reading and writing of the descriptor 1020, to “1” (step S100 illustrated in FIG. 13) and reads the flag AF #1 of n=1 from the descriptor 1020 (step S101 illustrated in FIG. 13).

In a case in which the flag AF #1 indicates that the start address is valid (Yes in Step S102 illustrated in FIG. 13), the DMA controller 1021 reads the start address A #1 of n=1 from the descriptor 1020 (Step S103 illustrated in FIG. 13) and writes a corresponding packet of n=1 into an area starting from the start address A #1 of the packet memory 101 (Step S104 illustrated in FIG. 13).

After completing the writing of the packet, the DMA controller 1021 writes a received data size L #1 indicating the packet length of the packet of n=1 and the reception completion flag WF #1 indicating that the writing of the packet has been completed into the descriptor 1020 (step S105 illustrated in FIG. 13).

In addition, the DMA controller 1021 generates a hardware interrupt to notify the processor (not illustrated) of the packet processing device of the completion of writing of the packet, and requests to activate the reception processing unit 103.

Then, the DMA controller 1021 determines whether the variable n is equal to N (step S106 illustrated in FIG. 13). In a case in which the variable n has not reached N (No in step S106), the DMA controller 1021 increases the variable n by one (step S107 illustrated in FIG. 13) and returns the process to step S101. In addition, in a case in which the variable n has reached N (Yes in step S106), the DMA controller 1021 returns the process to step S100. In this way, N packets are sequentially transferred to the packet memory 101.

Next, the activated reception processing unit 103 delivers the received packet that has been transferred to the packet memory 101 to the protocol processing unit 104. At the same time, the reception processing unit 103 secures an area of a new packet memory 101 from memories included in the packet processing device to supplement a packet memory corresponding to packets that have been delivered to the protocol processing unit 104.

When necessary protocol processing ends, the protocol processing unit 104 to which the received packets have been delivered releases an area of the packet memory 101.

As described above, in a general reception process, it is known that, particularly in a case in which small packets arrive at a high frequency, the number of interrupts of hardware increases, and thus, the processor of the packet processing device experiences a high load, and the reception performance is reduced. In addition, it is known that the number of times of DMA transfer activation increases, and thus the reception performance is reduced due to an overhead accompanying DMA transfer control.

In order to handle such problems, a technology for combining a plurality of small packets into one large combined packet until a threshold set in a line adapter is reached and DMA transferring the combined packet to a packet memory altogether with the size of the combined packet reaching the threshold as a trigger has been proposed (see Patent Literature 1).

By using such a DMA transfer system of combining a plurality of small packets into one combined packet and transferring the combined packet (hereinafter, referred to as collected DMA transfer), even in a case in which small packets arrive at a packet processing device, the number of hardware interrupts can be reduced, and the overhead of the DMA transfer can be reduced, whereby a high-speed reception process can be performed.

FIG. 14 is a block diagram illustrating a configuration of a packet processing device in a related art disclosed in Patent Literature 1. This packet processing device includes a line adapter 100, a packet memory 101, a combined packet transferring unit 102a, a reception processing unit 103, a protocol processing unit 104, a reception buffer 105, a packet combining unit 106, and a combination threshold control unit 107.

In the packet processing device illustrated in FIG. 14, the packet combining unit 106 transfers packets received by the line adapter 100 to the reception buffer 105 used for combining packets. At this time, the packet combining unit 106 stores packets in the reception buffer 105 such that one combined packet is formed by combining a packet received by the line adapter 100 and packets that have already been stored in the reception buffer 105. When the size of the combined packet in the reception buffer 105 exceeds a threshold set in the combination threshold control unit 107 in advance, the packet combining unit 106 issues a request for transferring the combined packet to the packet memory 101.

Similar to the case illustrated in FIG. 11, the combined packet transferring unit 102a includes a descriptor 1020a and a DMA controller 1021a. FIG. 15 is a diagram illustrating an overview of the descriptor 1020a. The example illustrated in FIG. 15 illustrates a case in which N combined packets are stored in the packet memory 101. In this case, a processor of the packet processing device sets an address and a flag corresponding to each of the N combined packets in the descriptor 1020a.

The processor sets start addresses AD #1 to AD #N, which are used when the combined packet is written into the packet memory 101, in the descriptor 1020a in advance. Generally, the number of addresses that can be simultaneously set is determined in advance, and the sequence of addresses to be used is also determined.

The processor sets/resets flags ADF #1 to ADF #N indicating whether the set addresses AD #1 to AD #N are valid for the descriptor 1020a. After setting the addresses AD #1 to AD #N, when the processor validates the flags ADF #1 to ADF #N, a combined packet can be written into the packet memory 101.

In addition, in the descriptor 1020a, reception completion flags WDF #1 to WDF #N indicating whether writing of combined packets into the set addresses AD #1 to AD #N has been completed and received data sizes LD #1 to LD #N indicating lengths of combined packets written into the set addresses A #1 to A #N (total values of packet lengths of combined packets) are set.

FIG. 16 is a flowchart illustrating operations of the DMA controller 1021a. First, the DMA controller 1021a initializes a variable n, which indicates the sequence of reading and writing of the descriptor 1020a to “1” (step S200 illustrated in FIG. 16) and reads a flag ADF #1 of n=1 from the descriptor 1020a (step S201 illustrated in FIG. 16).

In a case in which the flag ADF #1 indicates that the start address is valid (Yes in Step S202 illustrated in FIG. 16), the DMA controller 1021a reads the start address AD #1 of n=1 from the descriptor 1020a (step S203 illustrated in FIG. 16) and writes a corresponding combined packet of n=1 into an area starting from the start address AD #1 of the packet memory 101 (step S204 illustrated in FIG. 16).

After completing the writing of the combined packet, the DMA controller 1021a writes a received data size LD #1 indicating the length of the combined packet of n=1 and a reception completion flag WDF #1 indicating that the writing of the combined packet has been completed into the descriptor 1020a (step S205 illustrated in FIG. 16).

In addition, the DMA controller 1021a generates a hardware interrupt for notifying the processor (not illustrated) of the packet processing device of the completion of writing of a combined packet, and requests to activate the reception processing unit 103.

Then, the DMA controller 1021a determines whether the variable n is equal to N (step S206 illustrated in FIG. 16). In a case in which the variable n has not reached N (No in step S206), the DMA controller 1021a increases the variable by “i” (step S207 illustrated in FIG. 16), and the process is returned to Step S201. In a case in which the variable n has reached N (Yes in step S206), the DMA controller 1021a returns the process to step S200. In this way, N combined packets are sequentially transferred to the packet memory 101.

The reception processing unit 103 activated in response to the activation request from the combined packet transferring unit 102a (the DMA controller 1021a) delivers a combined packet transferred to the packet memory 101 to the protocol processing unit 104.

By employing the configuration illustrated in FIG. 14, a request for activating a reception process is performed when a combined packet acquired by combining a plurality of packets is transferred, and thus, the number of times the reception processing unit 103 is activated is reduced, and the load of the processor of the packet processing device is reduced. In addition, the number of times DMA transfer control is performed is reduced, and thus the ratio of an overhead becomes low, and high reception performance can be exhibited.

However, in the configuration illustrated in FIG. 14, the combined packet needs to be restored to a plurality of original packets by the protocol processing unit 104. When this restoration process is to be realized using hardware of the protocol processing unit 104, a means for the packet combining unit 106 to notify the protocol processing unit 104 of information required for the restoration process (the number of combined packets and a size of each packet) is required, and thus there is a problem in that the scale of the hardware of the packet combining unit 106 and the like becomes large. In addition, the information required for the restoration process needs to be stored in the packet memory 101 or the like.

Although the restoration process can be realized by software of the reception processing unit 103 or the like, as described above, a means for the packet combining unit 106 to notify the reception processing unit 103 of information required for the restoration process (the number of combined packets and a size of each packet) is required, and thus, there is a problem in that the scale of the hardware of the packet combining unit 106 and the like becomes large. In addition, because the restoration process is performed by software, a process according to the software is increased, and the load of the processor becomes high. As a result, there is also a problem in that improvement of the reception performance according to collected DMA transfer is inhibited.

FIG. 17 is a block diagram illustrating another configuration of a packet processing device. In this packet processing device, a combined packet separating unit 108 which restores a combined packet into a plurality of original packets is provided between the reception processing unit 103 and the protocol processing unit 104 of the packet processing device illustrated in FIG. 14.

Similar to a case in which the packet restoration process is realized by the hardware of the protocol processing unit 104, when the combined packet separating unit 108 is to be realized by hardware, a means for the packet combining unit 106 to notify the combined packet separating unit 108 of information required for the restoration process (the number of combined packets and a size of each packet) is required, and thus there is a problem in that the scale of the hardware of the packet combining unit 106 and the like becomes large.

Although the combined packet separating unit 108 can be realized by software, as described above, a means for the packet combining unit 106 to notify the combined packet separating unit 108 of information required for the restoration process (the number of combined packets and a size of each packet) is required, and thus, there is a problem in that the scale of the hardware of the packet combining unit 106 and the like becomes large. In addition, because the restoration process is performed by software, a process according to the software is increased, and the load of the processor becomes high. As a result, there is also a problem in that improvement of the reception performance according to collected DMA transfer is inhibited.

FIG. 18 is a block diagram illustrating another configuration of a packet processing device. In this packet processing device, instead of the combined packet transferring unit 102a of the packet processing devices illustrated in FIG. 14 and FIG. 17, a combined packet writing unit 109 using software is provided. Also in a packet processing device not using DMA transfer, there are cases in which effective throughput of writing for the packet memory 101 is improved in accordance with collecting a plurality of packets and writing the packets into the packet memory 101 using software (hereinafter, referred to as combined writing) (a case in which the packet memory 101 is configured by a DRAM and the like). In this way, also for a packet processing device performing collected writing, there are problems similar to those described above when a combined packet is restored to a plurality of original packets.

In addition, in a case in which all the processes illustrated in FIG. 18 (hardware processes performed inside the packet memory 101 and the line adapter 100 are excluded) are performed using software, information (the number of combined packets and a size of each packet) required for the restoration process needs to be stored in the packet memory 101 and the like, and there is a problem in that the capacity (the number of writable bits) of the packet memory 101 and the like needs to be larger than that of a case in which collected writing is not performed.

### CITATION LIST

### Patent Literature

Patent Literature 1: JP 4468332B.

### SUMMARY

### Technical Problem

The present disclosure is realized for solving the problems of the technology in a related art described above, and an object of the present disclosure is to provide a technology enabling realization of high reception performance according to effects of collected DMA transfer or collected writing by reducing the scale of hardware required for a process of restoring a combined packet into a plurality of original packets for a packet processing device using collected DMA transfer using hardware or collected writing using software.

### Means for Solving the Problem

A packet processing device according to the disclosure includes: a line adapter configured to receive packets from a communication line; a packet combining unit configured to generate a combined packet by combining a plurality of packets received from the communication line; a packet memory configured to store packets received from the communication line; and a combined packet transferring unit configured to DMA transfer the combined packet to the packet memory or write the combined packet to the packet memory using a processor, the combined packet having been generated by the packet combining unit, and the combined packet transferring unit writes information of an address of first data of each packet inside the combined packet on the packet memory into a descriptor that is a data area on a memory set in advance.

In addition, in one configuration example of the packet processing device according to the present disclosure, the combined packet transferring unit writes information of a received data size indicating a packet length of each packet inside the combined packet into the descriptor.

In addition, one configuration example of the packet processing device according to the present disclosure further includes a processing unit configured to read packets stored in the packet memory, and the processing unit reads packets from the packet memory based on information written in the descriptor and performs processing of the packets.

In addition, a packet processing method includes: generating a combined packet by combining a plurality of packets received from a communication line;

DMA transferring the combined packet to a packet memory, or writing the combined packet to a packet memory, wherein the packet memory is read by a processing unit that is configured to perform processing of the packets received from the communication line; and writing information of an address of first data of each packet inside the combined packet on the packet memory into a descriptor that is a data area on a memory set in advance.

In addition, one configuration example of the packet processing method according to the present disclosure further includes writing information of a received data size indicating a packet length of each packet inside the combined packet into the descriptor.

Furthermore, one configuration example of the packet processing method according to the present disclosure further includes reading packets from the packet memory based on information written in the descriptor and performing processing of the packets.

### Effects of Embodiments of the Invention

According to the present disclosure, a combined packet transferring unit is configured to DMA transfer a combined packet to a packet memory or to write a combined packet to a packet memory by the processor, wherein the packet memory is generated by a packet combining unit, and is configured to write information of an address on the packet memory of first data of each packet inside a combined packet into a descriptor that is a data area on a memory set in advance. According to a packet processing device including a combined packet transferring unit of the present disclosure, the scale of hardware required for the process of restoring a combined packet acquired by combining a plurality of packets into a plurality of the original packets can be smaller than that of a configuration of a technology in a related art, and high reception performance according to effects of collected DMA transfer or collected writing can be realized.

In addition, compared to a case in which the process of restoring a combined packet acquired by combining a plurality of packets to a plurality of the original packets is realized by software by employing the configuration in a related art, illustrated in FIG. 14 or illustrated in FIG. 17, the process of a processor required for processing one packet requires less load in a case in which the process of restoring a combined packet acquired by combining a plurality of packets to a plurality of the original packets is performed by hardware by employing a configuration according to the present disclosure. Therefore, there is an effect of improving reception performance (increasing the number of packets that can be processed per unit time). In addition, there is also an effect of reduction in processor power consumption required for processing one packet.

### BRIEF DESCRIPTION OF THE DRAWINGS

FIG. 1 is a block diagram illustrating a configuration of a packet processing device according to a first embodiment of the present invention.

FIG. 2 is a diagram illustrating an overview of a descriptor of a packet processing device according to the first embodiment of the present invention.

FIG. 3 is a flowchart illustrating operations of a transfer managing unit of a packet processing device according to the first embodiment of the present invention.

FIG. 4 is a flowchart illustrating operations of a DMA controller of a packet processing device according to the first embodiment of the present invention.

FIG. 5 is a flowchart illustrating operations of a DMA controller of a packet processing device according to the first embodiment of the present invention.

FIG. 6 is a flowchart illustrating operations of a reception processing unit of a packet processing device according to the first embodiment of the present invention.

FIG. 7 is a block diagram illustrating a configuration of a packet processing device according to a second embodiment of the present invention.

FIG. 8 is a diagram illustrating an overview of a descriptor of a packet processing device according to the second embodiment of the present invention.

FIG. 9 is a flowchart illustrating operations of a combined packet transferring unit of a packet processing device according to the second embodiment of the present invention.

FIG. 10 is a flowchart illustrating operations of a combined packet transferring unit of a packet processing device according to the second embodiment of the invention.

FIG. 11 is a block diagram illustrating a configuration of a packet processing device in a related art.

FIG. 12 is a diagram illustrating an overview of a descriptor of the packet processing device illustrated in FIG. 11.

FIG. 13 is a flowchart illustrating operations of a DMA controller of the packet processing device illustrated in FIG. 11.

FIG. 14 is a block diagram illustrating another configuration of a packet processing device in a related art.

FIG. 15 is a diagram illustrating an overview of a descriptor of the packet processing device illustrated in FIG. 14.

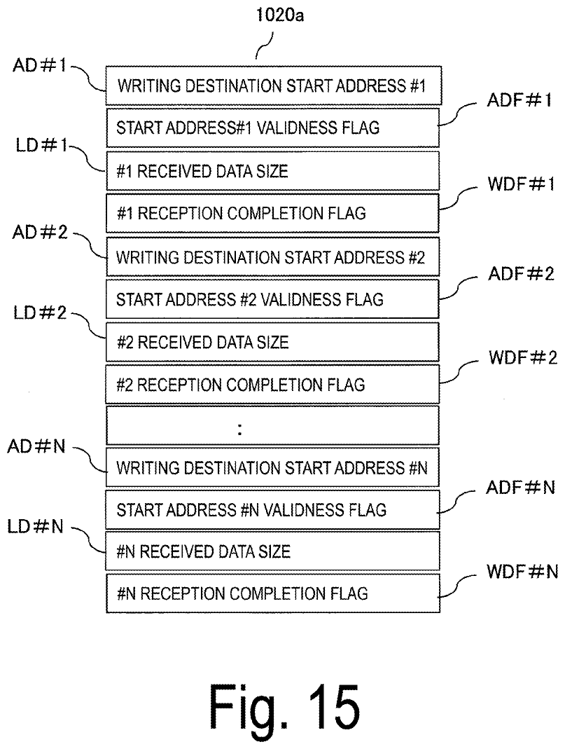

FIG. 16 is a flowchart illustrating operations of a DMA controller of the packet processing device illustrated in FIG. 14.

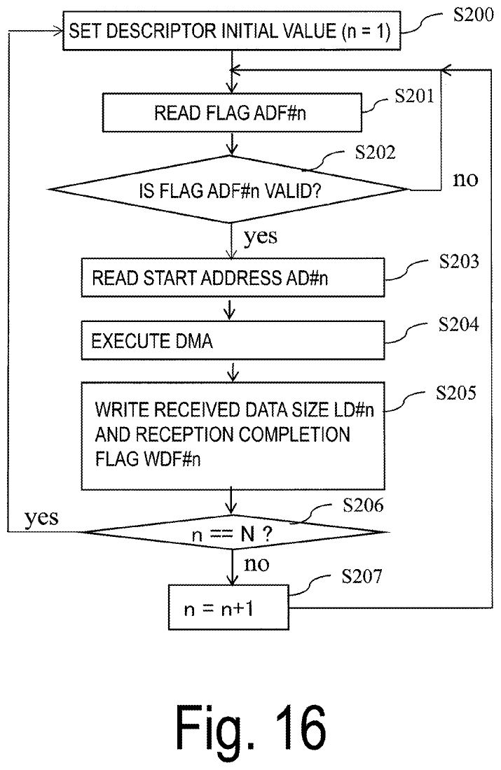

FIG. 17 is a block diagram illustrating another configuration of a packet processing device in a related art.

FIG. 18 is a block diagram illustrating another configuration of a packet processing device in a related art.

### DETAILED DESCRIPTION OF ILLUSTRATIVE EMBODIMENTS

### First Example

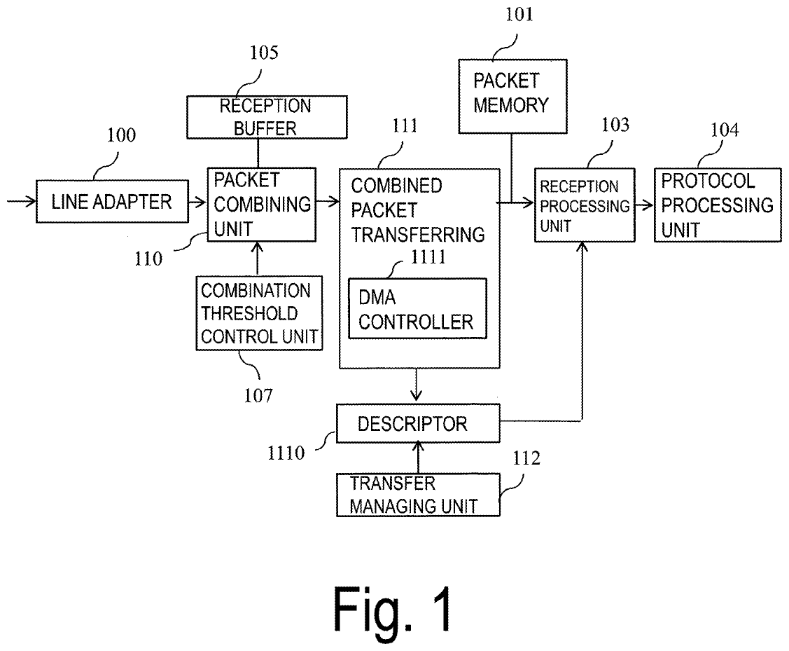

Hereinafter, an embodiment of the present disclosure will be described in detail with reference to the drawings. In all the drawings for describing an embodiment, the same reference signs will be assigned to units having the same functions, and repeated description thereof will be omitted. FIG. 1 is a block diagram illustrating a configuration of a packet processing device according to a first embodiment of the present invention.

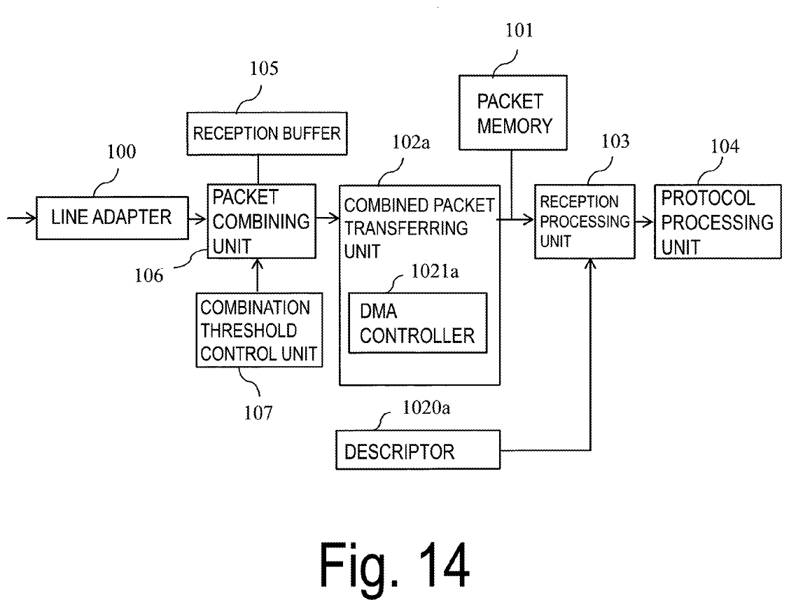

The packet processing device illustrated in FIG. 1 includes the following. A first component, similar to the configuration illustrated in FIG. 14, is a line adapter 100 that is connected to a communication line (not illustrated) and receives data from the communication line. A second component is a packet memory 101 that stores packets received from the communication line. A third component is a reception processing unit 103 that delivers packets stored in the packet memory 101 to a protocol processing unit 104. A fourth component is the protocol processing unit 104 that performs protocol processing of packets. A fifth component is a reception buffer 105 for combining packets. A sixth component is a combination threshold control unit 107 in which a threshold used for regulating the size of a combined packet is set in advance. A seventh component is a packet combining unit 110 that generates one combined packet by combining a plurality of packets received from the communication line in the reception buffer 105. An eighth component is a combined packet transferring unit 111 that performs DMA transfer of a combined packet generated by the packet combining unit 110 to the packet memory 101. A ninth component is a transfer managing unit 112 that performs initial setting of a descriptor 1110 that is a data area on a memory that is set in advance. The transfer managing unit 112 may be configured as a part of the reception processing unit 103.

Among these, the line adapter 100, the reception buffer 105 for combining packets, and the combination threshold control unit 107 are equivalent to the components illustrated in FIG. 14.

The packet combining unit 110 transfers packets received by the line adapter 100 to the reception buffer 105 for combining packets. At this time, the packet combining unit 110 stores packets in the reception buffer 105 such that a packet received by the line adapter 100 and packets stored in the reception buffer 105 in advance are connected to form one combined packet. When the size of the combined packet in the reception buffer 105 exceeds the threshold set in the combination threshold control unit 107, the packet combining unit 110 issues a request for transferring the combined packet to the packet memory 101.

In addition, the packet combining unit 110 may be configured to issue a transfer request in a case in which a timeout has occurred (in a case in which a reception interval between packets exceeds a period set in advance or the like) before the size of the combined packet in the reception buffer 105 exceeds the threshold.

In addition, the packet combining unit 110 records the number of packets combined in the reception buffer 105 and the size of each packet and notifies the combined packet transferring unit 111 of the number of combined packets and the size of each packet when issuing a request for transferring a combined packet.

The combined packet transferring unit 111 includes a DMA controller 1111. The combined packet transferring unit 111 transfers a combined packet to the packet memory 101 through one DMA transfer and issues a request for activating the reception processing unit 103 by generating a hardware interrupt.

In addition, the combined packet transfer unit 111 may be configured not to generate a hardware interrupt for the processor (not illustrated) of the packet processing device.

In addition, the combined packet transferring unit in writes a size and the like into the descriptor 1110 that is prepared for each packet by the transfer managing unit 112 (software executed by the processor) by using the information of the number of combined packets and the size of each packet notified of by the packet combining unit 110. Details of the configuration of the descriptor 1110 and the operations of the combined packet transferring unit in will be described later.

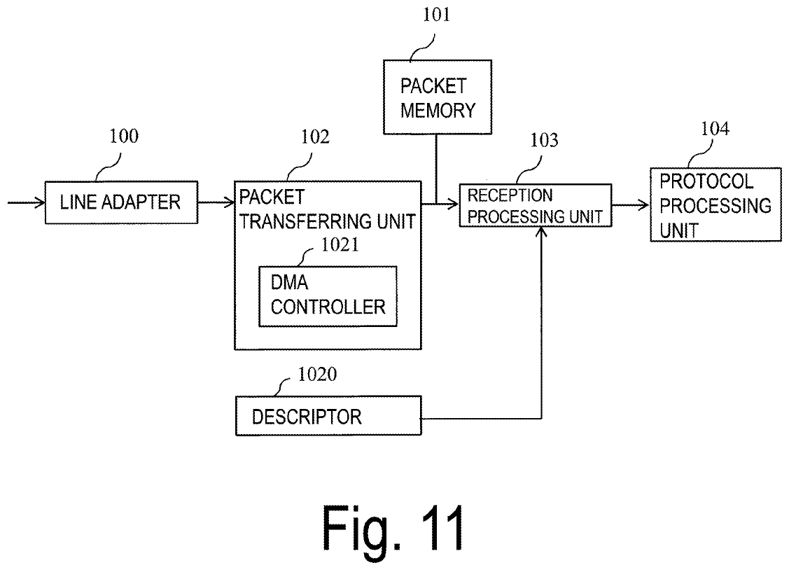

When an activation request is detected, the reception processing unit 103 reads packets stored in the packet memory 101 based on address information and size information written in the descriptor 1110 prepared for each packet and delivers the read packet to the protocol processing unit 104. At the same time, in order to supplement a packet memory corresponding to the packets delivered to the protocol processing unit 104, the reception processing unit 103 secures an area of a new packet memory 101 from memories included in the packet processing device. The operations of the reception processing unit 103 are equivalent to those of the configuration illustrated in FIG. 11.

The protocol processing unit 104 performs necessary protocol processing on the packets received from the reception processing unit 103. Then, when the necessary protocol processing ends, the protocol processing unit 104 releases an area of the packet memory 101 in which the packets delivered from the reception processing unit 103 are stored. The operations of this protocol processing unit 104 are equivalent to those of the configuration illustrated in FIG. 11.

The reception processing unit 103, the protocol processing unit 104, and the transfer managing unit 112 may be realized by software running on a general-purpose personal computer or a workstation or may be realized by hardware such as a field programmable gate array (FPGA) operating in cooperation with a program.

The packet memory 101 may be configured using a memory on a personal computer, a communication device, or a communication board.

The line adapter 100, the combination threshold control unit 107, and the packet combining unit no may be configured using an FPGA on a communication device or a communication board or the like.

The reception buffer 105 may be configured using a storage area included in an FPGA or the like on a communication device or a communication board or a storage circuit of a first in first out (FIFO) or the like.

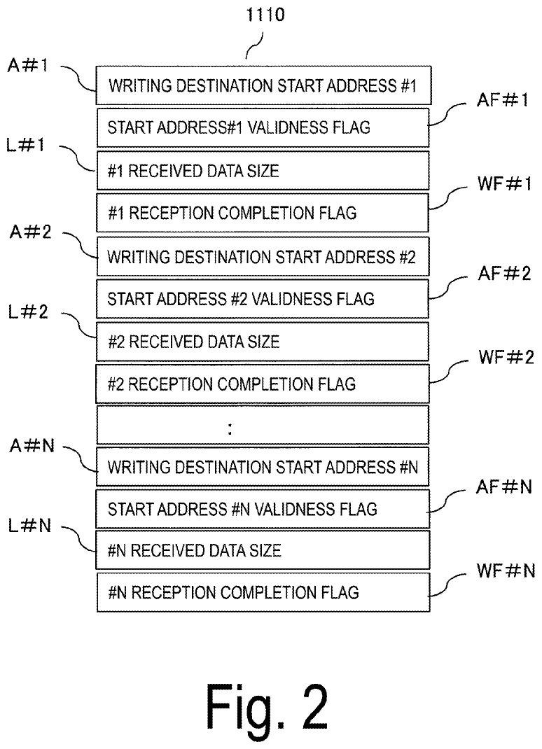

FIG. 2 illustrates a configuration example of the descriptor 1110 used by the combined packet transferring unit 111 according to this embodiment. Generally, a data structure that records an address of the packet memory 101 for reception processing and the like is referred to as a descriptor 1110. In the example illustrated in FIG. 2, a case in which N packets are stored in packet memory 101 is illustrated.

The descriptor 1110 illustrated in FIG. 2 is a data structure in which a plurality of (N sets of) start addresses A #1 to A #N of writing destinations of received packets, validness flags AF #1 to AF #N indicating whether the start addresses A #1 to A #N are valid, received data sizes L #1 to L #N indicating packet lengths of packets written into the start addresses A #1 to A #N, and reception completion flags WF #1 to WF #N indicating whether writing of packets into each of the start addresses A #1 to A #N has been completed can be written. This configuration of the descriptor 1110 is equivalent to the configuration of the descriptor 1020 for reception processing that is generally used in the configuration illustrated in FIG. 11.

The descriptor 1110, similar to the packet memory 101, is actually disposed inside a memory on a personal computer, a communication device, or communication board.

While the descriptor 1110 can be disposed inside the same memory as the packet memory 101, in such a case, the use of the memory can be divided in accordance with addresses inside the memory.

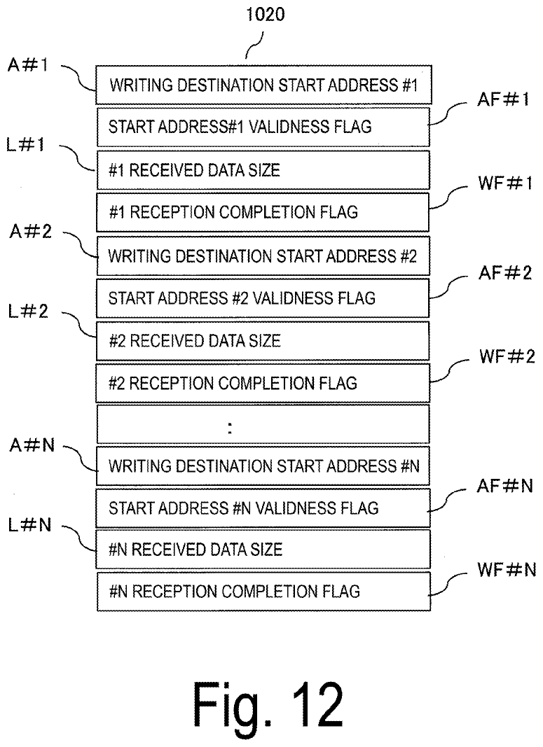

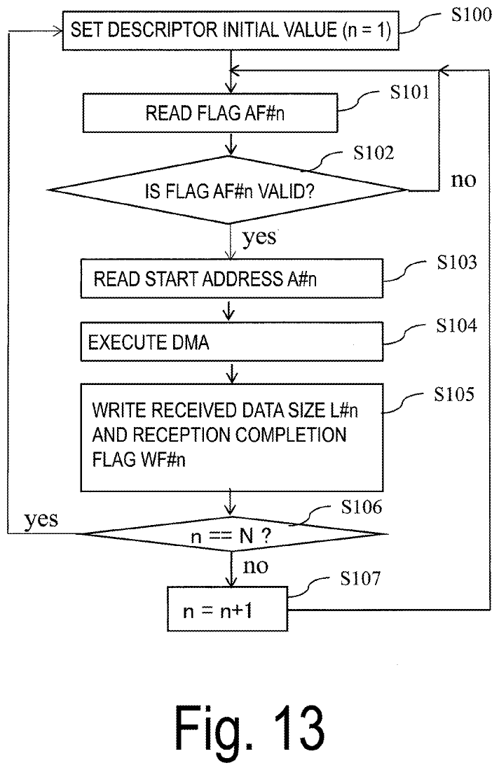

Here, an example of operations of DMA transfer in a related art using a descriptor 1020 in a related art will be described in detail again with reference to FIG. 12 and FIG. 13.

First, the processor of the packet processing device determines start addresses A #1 to A #N of writing destinations of the packets and writes the determined start addresses in the descriptor 1020 and rewrites the validness flags AF #1 to AF #N, which indicate whether the start addresses A #1 to A #N are valid, from “invalid” to “valid”.

While there are N sets of areas in the descriptor 1020 in which information of start addresses and the like is written, the writing sequence is determined in advance. For example, in the example illustrated in FIG. 12, the processor writes information in a sequence of a first start address A #1, a second start address A #2, . . . , and an N-th start address A #N.

When a first packet can be transferred again after the information is written once, start addresses may be written into the descriptor 1020 in a sequence from the first start address A #1. Regarding whether information can be written at the start address A #n (here, n is 1 to N), for example, it can be determined that the writing can be performed when the validness flag AF #n corresponding to the start address A #n is “invalid”.

Next, the DMA controller 1021 checks the validness flag AF #n of the descriptor 1020 and, in a case in which the validness flag AF #n indicates that the start address A #n is “valid” (Yes in Step S102 illustrated in FIG. 13), reads the start address A #n from the descriptor 1020 (step S103 illustrated in FIG. 13) and writes a corresponding n-th packet into an area starting from the start address A #n of the packet memory 101 (step S104 illustrated in FIG. 13).

After this DMA transfer is completed, the DMA controller 1021 writes a received data size L #n indicating a packet length of the n-th packet into the descriptor 1020 and rewrites the reception completion flag WF #n, which indicates that the writing of the n-th packet set in the descriptor 1020 has been completed, from “not-completed” to “completed” (step S105 illustrated in FIG. 13).

As described above, while there are N (sets of) areas of the validness flags AF #1 to AF #N in the descriptor 1020, the sequence in which the validness flags AF #1 to AF #N are checked is determined in advance. For example, in the example illustrated in FIG. 12 and FIG. 13, the DMA controller 1021 checks validness flags in a sequence of a first validness flag AF #1, a second validness flag AF #2, . . . , an N-th validness flag AF #N. After the checking is completed once, the validness flags are checked in a sequence from the first validness flag AF #1 again.

In the descriptor 1020, N sets of areas in which received data sizes L #1 to L #N and reception completion flags WF #1 to WF #N are written are prepared. The DMA controller 1021 writes the received data size L #n and the reception completion flag WF #n into an area with a number corresponding to the n-th validness flag AF #n from which the n-th start address A #n is checked to be “valid”.

Next, the processor of the packet processing device regularly checks the reception completion flag WF #n of the descriptor 1020 and, in a case in which the reception completion flag WF #n indicates “completed”, reads the n-th packet from the packet memory 101 using the information of the n-th start address A #n and the information of the n-th received data size L #n corresponding thereto and performs a necessary process (for example, protocol processing).

Then, the processor rewrites the n-th validness flag AF #n of the descriptor 1020, which corresponds to the n-th packet of which processing has been completed, from “valid” to “invalid” and rewrites the n-th reception completion flag WF #n of the descriptor 1020 from “completed” to “not-completed”.

In the descriptor 1020, while there are N (sets of) areas of reception completion flags WF #1 to WF #N, a sequence in which the reception completion flags WF #1 to WF #N are checked is determined in advance. For example, in the example illustrated in FIG. 12 and FIG. 13, the processor checks the reception completion flags in a sequence of a first reception completion flag WF #1, a second reception completion flag WF #2, . . . , an N-th reception completion flag WF #N. After the checking is completed once, the reception completion flags are checked in a sequence from the first reception completion flag WF #1 again.

Alternatively, the DMA controller 1021 makes an interrupt processing request for the processor after completion of DMA transfer and instead of the processor regularly checking the reception completion flags WF #1 to WF #N in the operations described above, the processor may be configured to check the reception completion flags WF #1 to WF #N when an interrupt processing request is received from the DMA controller 1021.

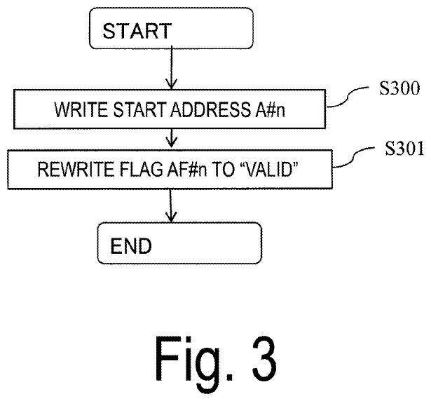

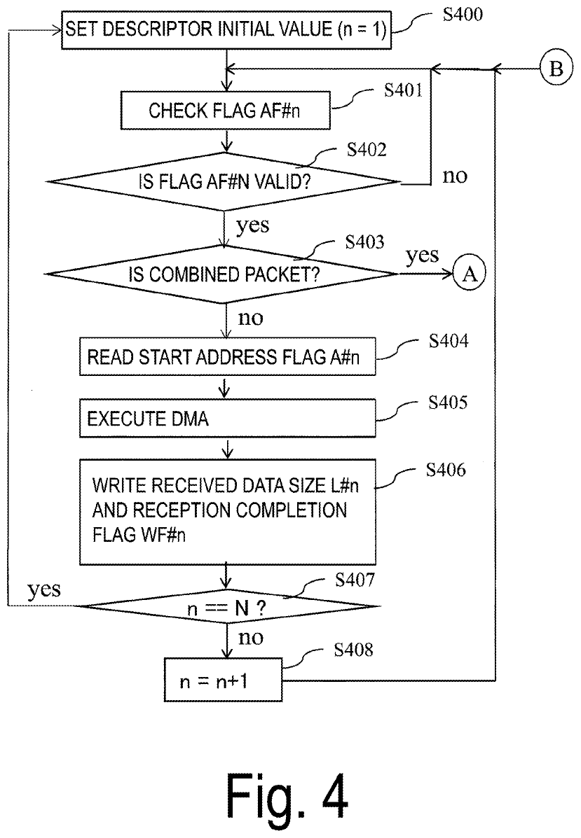

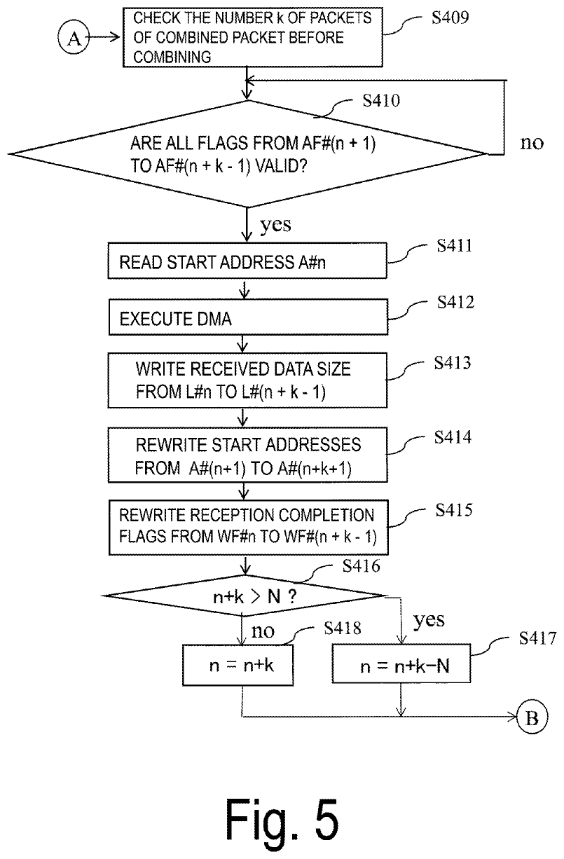

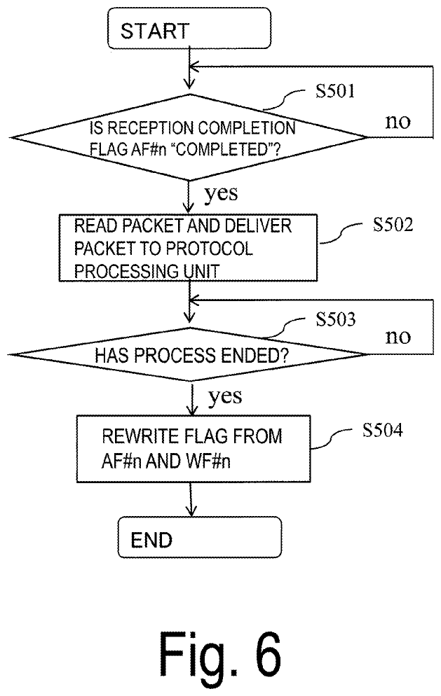

Next, an example of operations according to this embodiment using the descriptor 1110 having the configuration illustrated in FIG. 2 will be described with reference to FIG. 1 to FIG. 6. FIG. 3 is a flowchart illustrating operations of the transfer managing unit 112, FIG. 4 and FIG. 5 are flowcharts illustrating operations of the DMA controller 1111, and FIG. 6 is a flowchart illustrating operations of the reception processing unit 103.

First, the transfer managing unit 112 (software executed by the processor) determines an address of first data of each of N packets on the packet memory 101 as initial settings of the packet processing device, in other words, a start address A #n (here, n is 1 to N) of a writing destination of each packet and writes the start addresses into the descriptor 1020 (step S300 in FIG. 3). In addition, the transfer managing unit 112 rewrites the validness flag AF #n, which indicates whether the start address A #n is valid, from “invalid” to “valid” (step S301 illustrated in FIG. 3).

In the descriptor 1110, while N sets of areas in which information of start addresses and the like is to be written are prepared, a sequence in which information is written into the areas is determined in advance. For example, in the example illustrated in FIG. 2, the transfer managing unit 112 writes information in a sequence of the first start address A #1, the second start address a #2, . . . , the N-th start address A #N.

When a first packet can be transferred again after the information is written once, start addresses may be written into the descriptor 1110 in a sequence from the first start address A #1. Regarding whether information can be written at the start address A #n, for example, it can be determined that the writing can be performed when the validness flag AF #n corresponding to the start address A #n is “invalid”. This operation is equivalent to that of a technology in a related art.

First, the DMA controller 1111 inside the combined packet transferring unit 111 initializes a variable n, which indicates the sequence of reading and writing of the descriptor 1110, to “1” (step S400 illustrated in FIG. 4)

Then, when a transfer request is issued from the packet combining unit 110, the DMA controller 1111 checks the n-th validness flag AF #n of the descriptor 1110 (step S401 illustrated in FIG. 4).

In a case in which the validness flag AF #n indicates that the n-th start address A #n is “valid” (Yes in step S402 illustrated in FIG. 4), the DMA controller 1111 checks information from the packet combining unit 110 (the number of combined packets and the size of each packet) and checks whether data to be transferred to the packet memory 101 is a single packet that has not been combined or a combined packet (step S403 illustrated in FIG. 4).

In a case in which data to be transferred to the packet memory 101 is not a combined packet (in a case in which the number of combined packets is one), the DMA controller 1111 reads an n-th start address A #n for which a corresponding validness flag AF #n has been checked to be “valid” from the descriptor 1110 (step S404 illustrated in FIG. 4) and performs DMA transfer of writing a corresponding n-th packet into an area starting from the start address A #n of the packet memory 101 (step S405 illustrated in FIG. 4).

After the completion of this DMA transfer, the DMA controller 1111 writes the received data size L #n indicating the packet length of the n-th packet into the descriptor 1110 and rewrites the reception completion flag WF #n, which indicates that the writing of the n-th packet has been completed, set in the descriptor 1110 from “not-completed” to “completed” (step S406 illustrated in FIG. 4).

The DMA controller 1111 determines whether the variable n is equal to N (step S407 illustrated in FIG. 4). In a case in which the variable n has not reached N (No in step S407), the DMA controller 1111 increases the variable n by “i” (step S408 illustrated in FIG. 4) and returns the process to step S401. In a case in which the variable n has reached N (Yes in step S407), the DMA controller 1111 returns the process to step S400.

As described above, while N (sets of) areas of the validness flags AF #1 to AF #N are prepared in the descriptor 1110, a sequence in which the validness flags AF #1 to AF #N are checked is determined in advance. For example, in the example illustrated in FIG. 2 and FIG. 4, the DMA controller 1111 checks the validness flags in a sequence of the first validness flag AF #1, the second validness flag AF #2, . . . , the N-th validness flag AF #N. After the checking is completed once, the DMA controller 1111 initializes the variable n to “1” (step S400) and checks the validness flags in a sequence from the first validness flag AF #1.

In the descriptor 1110, N sets of areas in which received data sizes L #1 to L #N and reception completion flags WF #1 to WF #N are written are also prepared. The DMA controller 1111 writes the received data size L #n and the reception completion flag WF #n into an area of a number corresponding to the n-th validness flag AF #n from which the n-th start address A #n has been checked to be “valid”.

In a case in which the data to be transferred to the packet memory 101 is a combined packet (in a case in which the number k of combined packets is equal to or larger than two), the DMA controller 1111 checks the number k of combined packets (step S409 illustrated in FIG. 5) and checks (k−1) validness flags AF #(n+1) to AF #(n+k−1) inside the descriptor 1110 (step S410 illustrated in FIG. 5). Here, the reason for checking the (k−1) validness flags is that the n-th validness flag AF #n has already been checked in step S402.

In addition, in the case of n=N, the DMA controller 1111 may check the validness flags AF #1 to AF #(k−1). In a case in which n<N, and n+k−1>N, the DMA controller 1111 may check the validness flags AF #(n+1) to AF #N and from AF #1 to AF #(k−1−(N−n)).

In a case in which all the k validness flags that have been checked by the processes of steps S402 and S410 are “valid” (Yes in step S410), the DMA controller 1111 reads an n-th start address A #n corresponding to the first validness flag AF #n among the checked k validness flags from the descriptor 1110 (step S411 illustrated in FIG. 5) and performs DMA transfer of writing a corresponding combined packet into an area starting from the start address A #n of the packet memory 101 (step S412 illustrated in FIG. 5).

After the completion of this DMA transfer, the DMA controller 1111 writes received data sizes L #n to L #(n+k−1) representing packet lengths of packets configuring the combined packet that has been DMA transferred to the packet memory 101 into the descriptor 110 based on the information (the size of each of packets that have been combined) notified from the packet combining unit 110 (step S413 illustrated in FIG. 5).

In addition, in the case of n=N, the DMA controller 111 may write a received data size L #n and received data sizes from L #1 to L #(k−1) into the descriptor 110. In a case in which n<N and n+k−1>N, the DMA controller 111 may write a received data size L # and received data sizes from L #n(n+1) to L #N and from L #1 to L #(k−1−(N−n)) into the descriptor 1110.

Subsequently, the DMA controller 11 rewrites (k−1) start addresses A #(n+1) to A #(n+k−1) inside the descriptor 1110 in accordance with packet lengths of the first (k−1) packets among k packets configuring the combined packet (step S414 illustrated in FIG. 5).

More specifically, the DMA controller 1111 rewrites the start address A #(n+1) to a value acquired by adding the start address A #n and the packet length of the first packet (a value indicated by the received data size L #n) among k packets configuring the combined packet. In addition, the DMA controller 1111 rewrites an start address A #(n+k−1) to a value acquired by adding the start address A #(n+k−2) and the packet length of the (k− 1)-th packet (a value indicated by the received data size L #(n+k−2)) among k packets configuring the combined packet.

In this way, in a case in which a start address A #1 is to be rewritten, the DMA controller 1111 may rewrite the start address A #1 to a value acquired by adding a previous start address A #(i−1) and the packet length of an (i−1)-th packet among the packets configuring the combined packet.

Next, the DMA controller 1111 rewrites reception completion flags WF #n to WF #(n+k−1) each corresponding to the packets configuring the combined packet that has been DMA transferred to the packet memory 101 from “not-completed” to “completed” (step S415 illustrated in FIG. 5).

In addition, in the case of n=N, the DMA controller 1111 may rewrite the reception completion flag WF #n and the reception completion flags WF #1 to WF #(k−1) from “not-completed” to “completed”. In a case in which n<N, and n+k−1>N, the DMA controller 1111 may rewrite the reception completion flag WF #n, reception completion flags WF #(n+1) to WF #N, and reception completion flags WF #1 to WF #(k−1−(N−n)) to “completed”.

Then, the DMA controller 1111 checks whether “n+k>N” is satisfied (step S416 illustrated in FIG. 5) and, in a case in which (n+k) is larger than N, sets the variable to n=n+k−N (step S417 illustrated in FIG. 5) and causes the process to return to step S401. In addition, in a case in which (n+k) is equal to or smaller than N, the DMA controller 1111 sets the variable n to n=n+k (step S418 illustrated in FIG. 5) and returns the process to step S401.

In this way, in the DMA transfer according to this embodiment, by arranging a combined packet in which k packets are combined, transferring the combined packet to the packet memory 101, and partially rewriting the information of the start addresses of the descriptor 1110, an address in which the start of each packet is written is notified to the processor (the reception processing unit 103 and the protocol processing unit 104) of the packet processing device.

The reception processing unit 103 (software executed by the processor) regularly checks the reception completion flags WF #n (here, n is 1 to N) of the descriptor 1110 and, in a case in which the reception completion flag WF #n indicates “completed” (Yes in step S501 illustrated in FIG. 6), reads an n-th packet from the packet memory 101 based on the information of an n-th start address A #n and the information of the received data size L #n corresponding thereto, and delivers the read n-th packet to the protocol processing unit 104 (step S502 illustrated in FIG. 6).

After a necessary process is performed by the protocol processing unit 104 (Yes in step S503 illustrated in FIG. 6), the reception processing unit 103 (software executed by the processor) rewrites an n-th validness flag AF #n of the descriptor 1110 that corresponds to the n-th packet of which protocol processing has been completed from “valid” to “invalid” and rewrites the n-th reception completion flag WF #n of the descriptor 1110 from “completed” to “not-completed” (step S504 illustrated in FIG. 6).

In the descriptor 1110, while there are N (sets of) areas of the reception completion flags WF #1 to WF #N, a sequence in which the reception completion flags WF #1 to WF #N are checked is determined in advance. For example, the reception processing unit 103 (software executed by the processor) checks reception completion flags in a sequence of the first reception completion flag WF #1, the second reception completion flag WF #2, . . . , the N-th reception completion flag WF #N. After the checking is completed once, the reception processing unit 103 checks the reception completion flags from the first reception completion flag WF #1 again.

In addition, instead of regularly checking the reception completion flags WF #n of the descriptor 1110, the DMA controller 1111 may be configured to issue an interrupt processing request for the processor after the completion of the DMA transfer, and the reception processing unit 103 (software executed by the processor) may be configured to check the reception completion flags WF #n (here, n is 1 to N) of the descriptor 1110 in response to this interrupt processing request.

The operations of the processor (software) described above are equivalent to the operations of the processor (software) of a technology in a related art having the configuration of FIG. 11, and the process of restoring a combined packet into a plurality of original packets does not need to be realized using software for a reception process. In other words, the reception processing unit 103 and the protocol processing unit 104 may perform the same process as in a case in a related art even in the case where a combined packet is written into the packet memory 101 as in this embodiment.

As described above, the packet processing device according to this embodiment includes the combined packet transferring unit 11 in which a means (the DMA controller 1111) that can realize collected DMA transfer and write information used for restoring a combined packet into a plurality of original packets into the descriptor 1110 is built in. The DMA controller 1111 can be realized by hardware, and thus a restoration process using software does not need to be executed, and high reception performance according to effects of the collected DMA transfer can be realized.

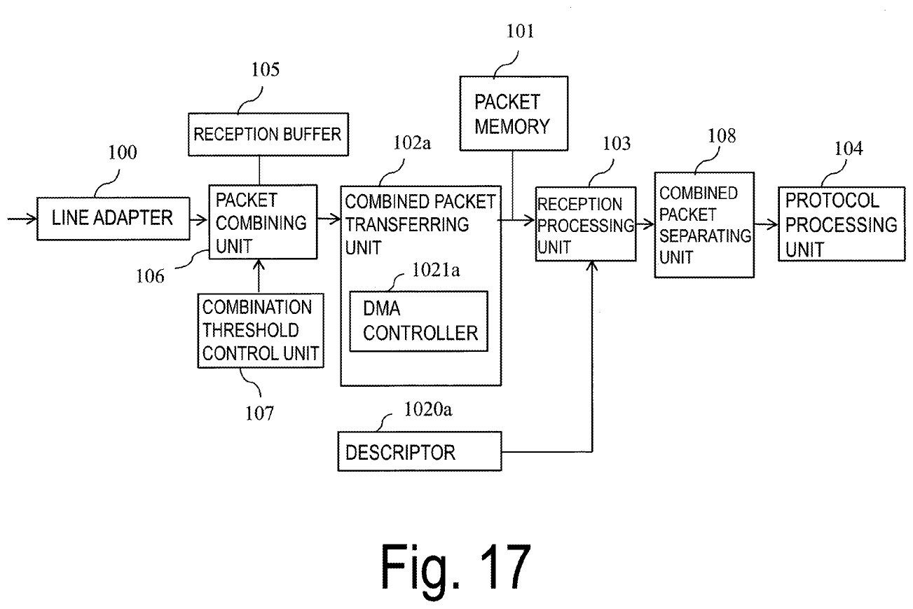

In addition, compared to a case in which the process of restoring a combined packet to a plurality of original packets is executed by the processor (software) in the packet processing device having the configuration in a related art illustrated in FIG. 14 or the configuration illustrated in FIG. 17, in this embodiment, the restoration process does not need to be performed using the processor (software). Therefore, the process of the processor required for processing one packet becomes light, and there is an effect of improving the reception performance (increasing the number of packets that can be processed per unit time). In addition, in this embodiment, there is also an effect of decreasing the power consumption of the processor that is required for processing one packet.

In this embodiment, software used for the reception processing unit 103 and the protocol processing unit 104 having the configuration illustrated in FIG. 1 can be directly used in the packet processing device according to this embodiment. This illustrates that, by simply changing the hardware (the DMA controller 11n), improvement of reception performance according to collected DMA can be realized.

In addition, in this embodiment, an address area on the packet memory 101 that is prepared by the processor (software) is shared by a plurality of packets, and therefore, the address area cannot be reused until the process of receiving all the packets sharing the area (transferring all the packets to the protocol processing unit 104) is completed.

The transfer managing unit 112 (software executed by the processor) needs to prepare an address area having a size for which a combined packet having a maximum size can be written and set the address area in the descriptor 110. The maximum size of the combined packet has a value acquired by adding an allowed maximum packet length to a threshold set by the combination threshold control unit 107.

In addition, in order to normally perform collected DMA transfer using the packet processing device according to this embodiment, the transfer managing unit 112 (software executed by the processor) needs to secure a buffer area of NxDB_mux (here, DB_mux is a maximum size of a combined packet) inside the packet memory 101 in advance. Such area securement is equivalent to that of the case of the configuration illustrated in FIG. 14.

For example, in this embodiment, in a case in which the buffer area described above is prepared in a continuous area inside the packet memory 101, a start address of this buffer area is the start address A #1, which is illustrated in FIG. 2, set by the transfer managing unit 112 (software executed by the processor). On the other hand, a last address of the buffer area becomes the start address A #1+(N×DB_mux)−1. In this case, the start address A #N, which is illustrated in FIG. 2, set by the transfer managing unit 112 (software executed by the processor) is the start address A #1+(N−1)×DB_mux.

In accordance with such area securement, even in a case in which a transfer destination address of DMA transfer of a combined packet becomes A #N, an area corresponding to DB_mux is secured in the packet memory 101 from this address A #N to a last address of the buffer area described above, and therefore, a combined packet can be reliably written in a continuous area corresponding to DB_mux.

In a case in which an area from the address A #N to the last address of the buffer area is smaller than DB_mux, a case in which a part of the combined packet to be written is written into an area in which the combined packet is not to be originally written occurs.

In addition, for example, in a case in which a buffer area to be secured inside the packet memory 101 is prepared as not a continuous area but N non-continuous areas, by preparing N areas corresponding to DB_mux in advance and setting start addresses of the areas to A #1 to A #N by the transfer managing unit 112 (software executed by the processor), a combined packet can be reliably written into a continuous area corresponding to DB_mux, and a defect of writing a combined packet into an area in which the combined packet is not to be written originally does not occur.

In the packet processing device according to this embodiment, the DMA controller 1111 rewrites the information (the start address, the received data size, and the reception completion flag) of the descriptor 1110 after DMA transfer, whereby a restoration process using software is not required.

In order to realize the restoration process using hardware of the reception processing unit 103, the protocol processing unit 104, or the combined packet separating unit 108 illustrated in FIG. 17, a means for the packet combining unit 106 to notify the reception processing unit 103 and the protocol processing unit 104 or the combined packet separating unit 108 illustrated in FIG. 17 of information (the number of combined packets and the size of each packet) required for the restoration process is required.

In addition, in order to realize the restoration process by hardware of the reception processing unit 103, the protocol processing unit 104, or the combined packet separating unit 108 illustrated in FIG. 17, it should be considered that information, which is required for the restoration process, corresponding to a plurality of combined packets needs to be stored depending on a situation until a reception process is activated after the completion of DMA transfer.

In contrast to this, in the packet processing device according to this embodiment, the restoration process for a combined packet is completed at a time point at which DMA transfer of one combined packet is completed, and therefore, information corresponding to a plurality of combined packets does not need to be stored. Therefore, the scale of the hardware according to this embodiment is smaller than that of a case in which the restoration process is realized by hardware of the reception processing unit 103, the protocol processing unit 104, or the combined packet separating unit 108 illustrated in FIG. 17.

In addition, as a means for the packet combining unit 106 to notify the reception processing unit 103, the protocol processing unit 104, or the combined packet separating unit 108 illustrated in FIG. 17 of information required for the restoration process, the information required for the restoration process may be written inside a combined packet. More specifically, in order to notify of the size of each combined packet, for example, a method in which a header in which a packet size and the like are written is added before each packet, and the added header is DMA transferred together with packet data may be considered.

However, in a case in which information required for the restoration process is written inside a combined packet, a part of the band of a bus used for the DMA transfer is occupied by the information required for the restoration process. Therefore, an effective band that can be used for transferring the original packet data decreases, and, as a result, there is a problem in that the performance of the DMA transfer deteriorates.

In the packet processing device according to this embodiment, the information required for the restoration process does not need to be written into a combined packet, and therefore, the deterioration of the effective band as described above does not occur.

Although an example in which the combined packet transferring unit 11 is realized by hardware has been illustrated in this embodiment, at least some processes of the combined packet transferring unit 111 may be realized by a processor different from the processor used for a reception process and software. Even in a case in which at least some of the processes of the combined packet transferring unit 111 are realized by software in this way, the process of restoring a combined packet to a plurality of original packets does not need to be performed by the reception processing unit 103 or the protocol processing unit 104, whereby high reception performance according to effects of collected DMA transfer can be realized.

In addition, even in a case in which at least some of the processes of the combined packet transferring unit 111 are realized by software, similar to a case in which the combined packet transferring unit 111 is realized by hardware, an effect of decreasing the scale of the hardware required for the process of restoring a combined packet to a plurality of original packets (an effect owing to no need for storing information corresponding to a plurality of combined packets) and an effect of no occurrence of deterioration of the effective band that can be used for transferring packet data (an effect owing to no addition of information required for the restoration process inside a combined packet) can be acquired.

As a variation of this embodiment, an area of a rewrite execution flag indicating whether a start address has been rewritten may be added to the descriptor 1110. For example, in a case in which the processor mounting the transfer managing unit 112 performing initial setting of the start addresses A #1 to A #N includes a cache storage device, the start addresses A #1 to A #N written in the descriptor 1110 are copied to inside the cache storage device.

However, when a start address stored inside the descriptor 1110 is rewritten by the DMA controller 1111, there are cases in which corresponding information inside the cache storage device of the processor mounting the transfer managing unit 112 is not rewritten. Also in such cases, the processor can refer to the rewrite execution flag for reading not the information stored inside the cache storage device but the information stored inside the descriptor 1110.

More specifically, the processor may read and use the information stored inside the cache storage device in a case in which it is determined that start addresses stored inside the descriptor 1110 cannot be rewritten as a result of referring to the rewrite execution flag and may temporarily invalidate the cache and directly use and read start addresses stored inside the descriptor 1110 in a case in which it is determined that start addresses stored inside the descriptor 110 can be rewritten.

The combined packet transferring unit 11 may rewrite a corresponding rewrite execution flag stored inside the descriptor 1110 from “non-rewritten” to “rewritten” when the start address stored inside the descriptor 110 are rewritten in the process of step S414 illustrated in FIG. 5.

As another modified example of this embodiment, in addition to the area of start addresses written by the transfer managing unit 112 (software executed by the processor), an area in which start addresses after change are written by the DMA controller 1111 may be prepared in the descriptor 1110. In such a case, the reception processing unit 103 (software executed by the processor) refers to the area in which start addresses after change are written. The process described in step S414 illustrated in FIG. 5 is a process not for rewriting start address but for writing start addresses after change.

In addition, in this embodiment, a plurality of DMA controllers 1111 and a plurality of descriptors 1110 corresponding to the DMA controllers 1111 may be configured to be mounted. In addition, the packet combining unit 110 may be configured to determine a type of packet and collect packets of the same type as a combined packet or may be configured to use the plurality of DMA controllers 1111 and the plurality of descriptors 1110 in a divisional manner in accordance with a type of packet.

When a configuration in which a DMA controller 1111 and a descriptor 1110 are prepared for each type of packet, and a plurality of DMA controllers 1111 and a plurality of descriptors 1110 are used in a divisional manner in accordance with a type of packet is employed, a different reception process may be easily performed for each type of packet.

In addition, in this embodiment, a configuration in which a plurality of DMA controllers 1111 and a plurality of descriptors 1110 are used in a divisional manner for each core of the processor in which a plurality of CPU cores are built may be employed, or a configuration in which a plurality of DMA controllers 1111 and a plurality of descriptors 1110 are used in a divisional manner for each virtual machine may be employed.

By employing the configuration in which the plurality of DMA controllers 1111 and the plurality of descriptors 1110 are used in a divisional manner for each CPU core or for each virtual machine, the performance of the reception process implemented by software can be improved compared to a case in which there is only one DMA controller or the like.

### Second Example

Next, a second example of the present invention will be described. Although the first embodiment has been described on the premise of a case in which DMA transfer is used, there are cases in which effective throughput of writing for the packet memory increases in accordance with collective writing of collecting a combined packet acquired by combining a plurality of packets and writing the combined packet in the packet memory increases (for example, a case in which the packet memory is configured using a dynamic random access memory (DRAM) and the like) also in a packet processing device not using DMA transfer.

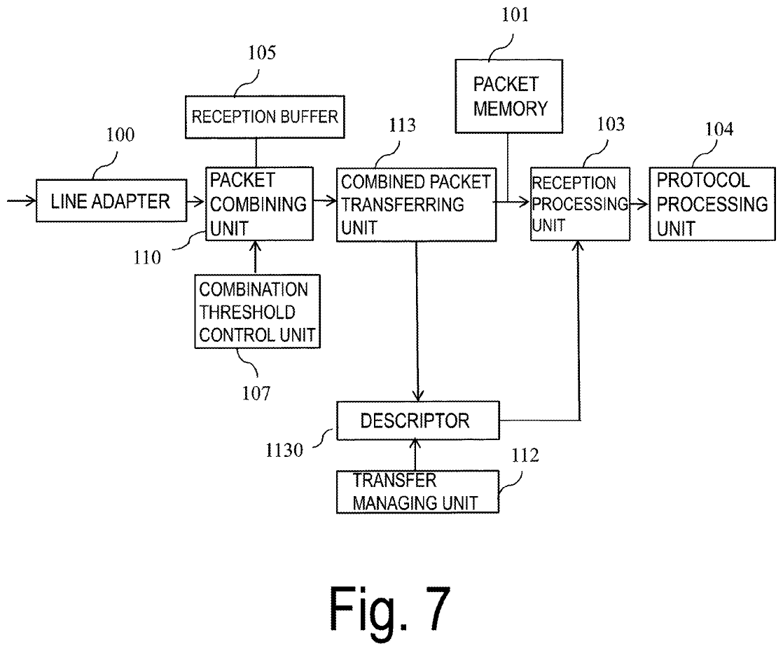

FIG. 7 is a block diagram illustrating a configuration of a packet processing device according to the second embodiment of the present invention. The packet processing device illustrated in FIG. 7 includes a line adapter 100, a packet memory 101, a reception processing unit 103, a protocol processing unit 104, a reception buffer 105, a combination threshold control unit 107, a packet combining unit 110, a transfer managing unit 112, and a combined packet transferring unit 113.

A difference between the configuration illustrated in FIG. 7 and the configuration illustrated in FIG. 1 is that the transfer means illustrated in FIG. 1 is replaced by a writing means according to a processor (software) of the packet processing device. In other words, this embodiment is acquired by replacing the combined packet transferring unit in illustrated in FIG. 1 with the combined packet transferring unit 113 according to software.

The line adapter 100, the packet memory 101, the reception processing unit 103, the protocol processing unit 104, the reception buffer 105, the combination threshold control unit 107, and the transfer managing unit 112 are equivalent to the components illustrated in FIG. 1.

The packet combining unit 110 illustrated in FIG. 7 transfers packets received by the line adapter 100 to the reception buffer 105 for combining packets. At this time, the packet combining unit 110 stores the packet in the reception buffer 105 so as to combine the packet received by the line adapter 100 and packets already stored in the reception buffer 105 to become one combined packet. When the size of a combined packet in the reception buffer 105 exceeds a threshold set by the combination threshold control unit 107, the packet combining unit 110 issues a request for transferring the combined packet to the packet memory 101.

In addition, the packet combining unit 110 may be configured to issue a transfer request in a case in which a timeout has occurred (in a case in which a reception interval between packets exceeds a period set in advance or the like) before the size of the combined packet in the reception buffer 105 exceeds the threshold.

In addition, the packet combining unit 110 records the number of packets combined in the reception buffer 105 and the size of each packet and notifies the combined packet transferring unit 113 of information of the number of combined packets and the size of each packet when issuing a request for transferring a combined packet.

The combined packet transferring unit 113 (software executed by the processor) writes a combined packet in which a plurality of packets are combined into the packet memory 101 and requests to activate the reception processing unit 103. In addition, the combined packet transferring unit 113 (software executed by the processor) writes information such as size and the like into the descriptor 1130 prepared for each packet using the information of the number of packets combined and the size of each packet notified from the packet combining unit 110.

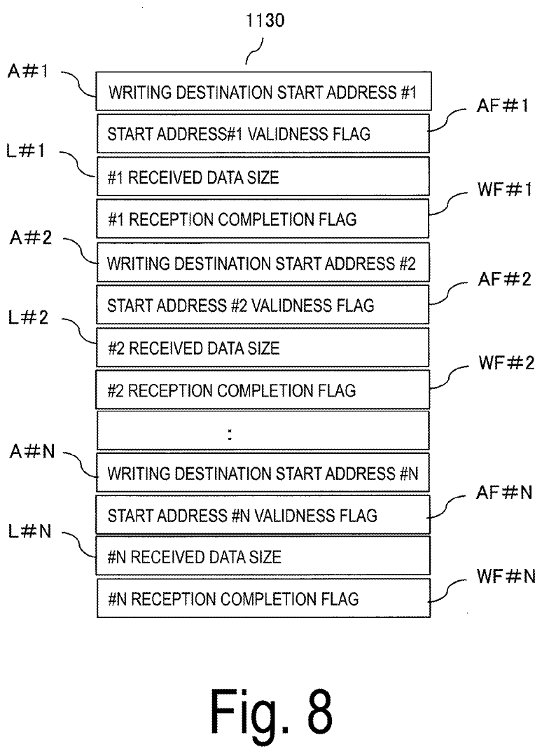

As illustrated in FIG. 8, the configuration of the descriptor 1130 is equivalent to that of the descriptor 1110 according to the first embodiment. However, in this embodiment, the combined packet transferring unit 113 (software executed by the processor) performs writing for the descriptor 1130 instead of the combined packet transferring unit 111, which is different from that according to the first embodiment.

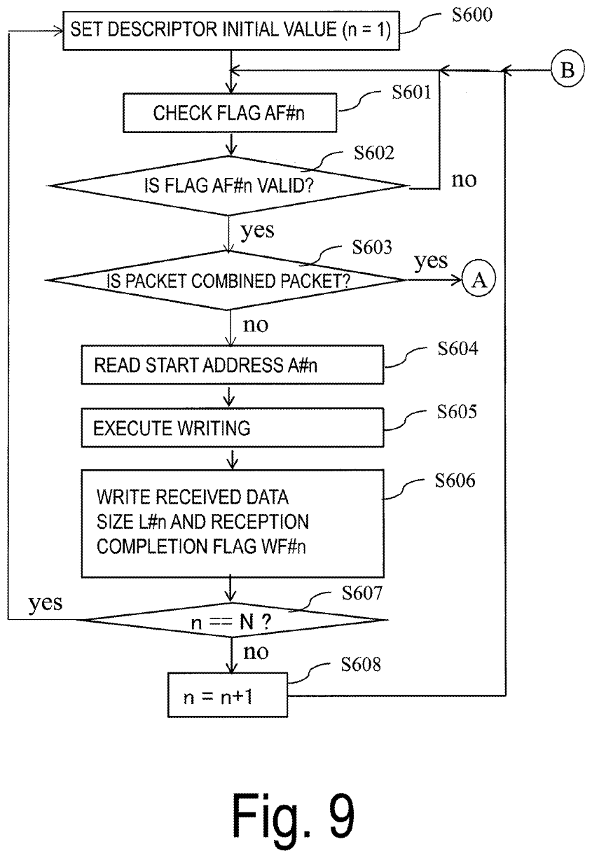

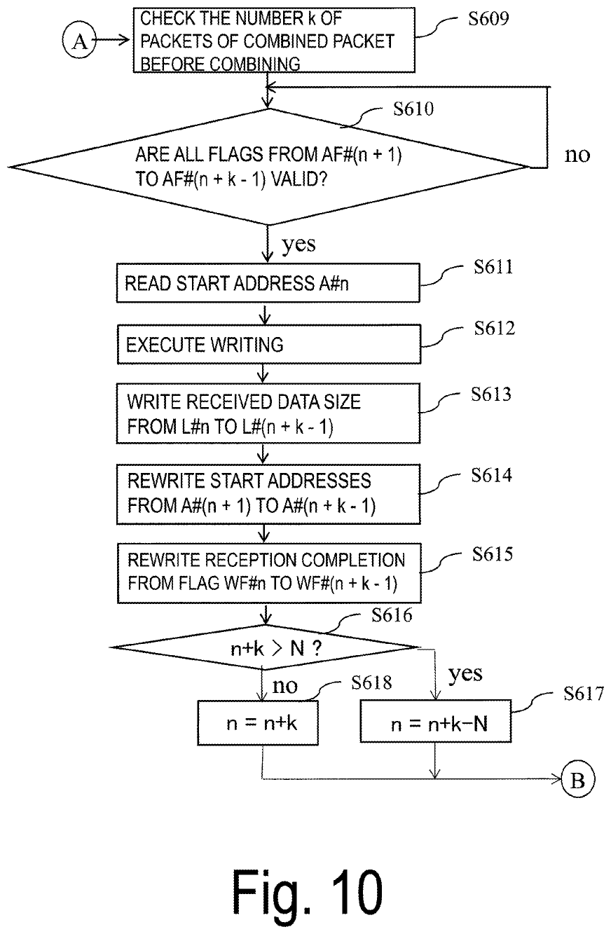

FIG. 9 and FIG. 10 are flowcharts illustrating operations of the combined packet transferring unit 113 (software executed by the processor). First, the combined packet transferring unit 113 initializes the variable n to “1” (step S600 illustrated in FIG. 9) and checks the validness flag AF #n of the descriptor 1130 after the transfer request is issued from the packet combining unit 110 (step S601 illustrated in FIG. 9).

In a case in which the validness flag AF #n indicates that the start address A #n is “valid” (Yes in step S602 illustrated in FIG. 9), the combined packet transferring unit 113 checks whether data to be transferred to the packet memory 101 is a single packet or a combined packet by checking the information from the packet combining unit 110 (step S603 illustrated in FIG. 9).

In a case in which the data to be transferred to the packet memory 101 is not a combined packet, the combined packet transferring unit 113 reads a start address A #n of which the validness flag AF #n has been checked to be “valid” from the descriptor 1130 (step S604 illustrated in FIG. 9) and writes a corresponding n-th packet into an area starting from the start address A #n of the packet memory 101 (Step S605 illustrated in FIG. 9).

After completion of this writing, the combined packet transferring unit 113 writes the received data size L #n into the descriptor 1130 and rewrites the reception completion flag WF #n set in the descriptor 1130 from the “not-completed” to “completed” (step S606 illustrated in FIG. 9). The processes of steps S600 to S606 and steps S607 and S608 are equivalent to the processes of steps S400 to S408 illustrated in FIG. 4.

In a case in which the data to be transferred to the packet memory 101 is a combined packet, the combined packet transferring unit 113 checks the number of k combined packets (step S609 illustrated in FIG. 10) and checks (k−1) validness flags AF #(n+1) to AF #(n+k−1) inside the descriptor 1130 (step S610 illustrated in FIG. 10).

In a case in which all the checked k validness flags are “valid” (Yes in step S610), the combined packet transferring unit 113 reads a start address A #n corresponding to the first validness flag AF #n among the checked k validness flags from the descriptor 1130 (step S611 illustrated in FIG. 10) and writes a corresponding combined packet into an area starting from the start address A #n of the packet memory 101 (step S612 illustrated in FIG. 1).

After completion of this writing, the combined packet transferring unit 113 writes received data sizes L #n to L #(n+k−1) indicating packet lengths of the packets configuring the combined packet written into the packet memory 101 into the descriptor 1130 (step S613 illustrated in FIG. 1).

Subsequently, the combined packet transferring unit 113 rewrites (k−1) start addresses A #(n+1) to A #(n+k−1) inside the descriptor 1130 in accordance with the packet lengths of the first (k−1) packets among the k packets configuring the combined packet (step S614 illustrated in FIG. 1).

Next, the combined packet transferring unit 113 rewrites the reception completion flags WF #n to WF #(n+k−1) corresponding to each packet configuring the combined packet written into the packet memory 101 from “not-completed” to “completed” (step S615 illustrated in FIG. 1).

The processes of steps S609 to S615 and steps S616 to S618 described above are equivalent to those of steps S409 to S418 illustrated in FIG. 5. In steps S610, S613, and S615, in a case in which n=N or n<N and n+k−1>N, the processes described in steps S410, S413, and S415 may be performed.

In this way, the packet processing device according to this embodiment includes a means (the combined packet transferring unit 113) that can realize collected writing and write information used for restoring a combined packet into a plurality of original packets into the descriptor 1130. According to this embodiment, execution of the reception processing unit 103 of the restoration process, the protocol processing unit 104, or the combined packet separating unit 108 illustrated in FIG. 17 is not necessary, and high reception performance owing to effects of collected writing can be realized.

In this embodiment, software for the reception processing unit 103 and the protocol processing unit 104 having the configuration illustrated in FIG. 1i can be directly used in the packet processing device according to this embodiment.

In addition, in order to normally perform collected writing described with reference to FIG. 9 and FIG. 10 using the packet processing device according to this embodiment, the transfer managing unit 112 (software executed by the processor) needs to secure a buffer area of NxDB_mux (here, DB_mux is a maximum size of a combined packet) inside the packet memory 101 in advance. This area securement is equivalent to that of the case of the configurations illustrated in FIG. 14 and FIG. 1.

In the packet processing device according to this embodiment, the combined packet transferring unit 113 rewrites the information (the start address, the received data size, and the reception completion flag) of the descriptor 1130 after completion of collected writing, a restoration process is not required.

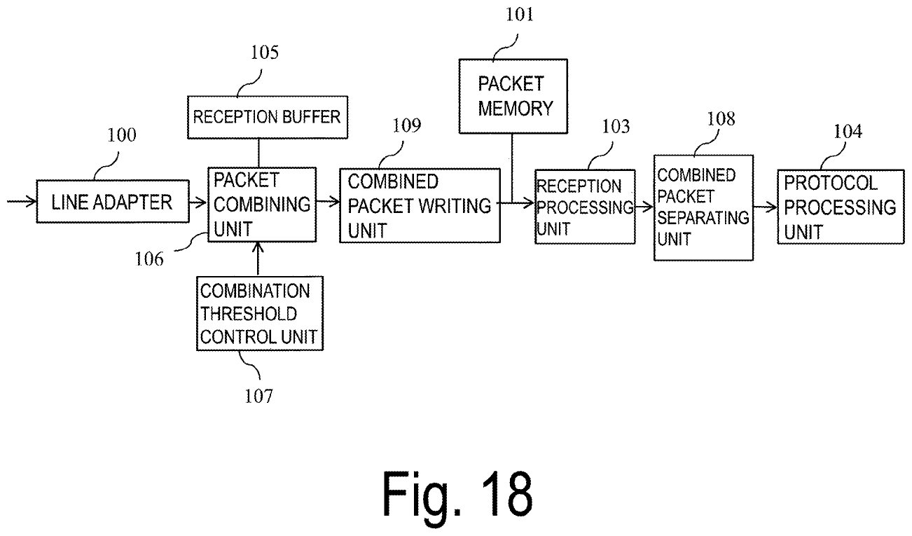

In order to realize the restoration process using the reception processing unit 103, the protocol processing unit 104, or the combined packet separating unit 108 illustrated in FIG. 18, a means for the packet combining unit 106 to notify the reception processing unit 103 and the protocol processing unit 104 or the combined packet separating unit 108 illustrated in FIG. 18 of information (the number of combined packets and the size of each packet) required for the restoration process is required.

In addition, in order to realize the restoration process using the reception processing unit 103, the protocol processing unit 104, or the combined packet separating unit 108 illustrated in FIG. 18, it should be considered that information, which is required for the restoration process, corresponding to a plurality of combined packets needs to be stored depending on a situation until a reception process is activated after completion of the collected writing.

In contrast to this, in the packet processing device according to this embodiment, the restoration process for a combined packet is completed at a time point at which collected writing of one combined packet is completed, and therefore, information corresponding to a plurality of combined packets does not need to be stored. Therefore, the scale of the hardware according to this embodiment is smaller than that of a case in which the restoration process is realized using the reception processing unit 103, the protocol processing unit 104, or the combined packet separating unit 108 illustrated in FIG. 18. This is the same also when compared to a case in which the process of restoring a combined packet into a plurality of original packets is implemented by software.

For example, in a case in which all the components other than the packet memory 101 and the line adapter 100 in the configuration illustrated in FIG. 18 are realized by software, the information (the number of combined packets and a size of each packet) required for a restoration process corresponding to a plurality of combined packets needs to be stored in the packet memory 101 or the like.

In contrast to this, in a case in which all the components other than the packet memory 101 and the line adapter 100 are realized by software in the configuration according to this embodiment, information corresponding to a plurality of combined packets (the number of combined packets and a size of each packet) does not need to be stored, in other words, the information (the number of combined packets and a size of each packet) required for the restoration process corresponding to only one combined packet may be stored in the packet memory 101 or the like.

In other words, in the configuration according to this embodiment, the capacity (the number of writeable bits) of the packet memory 101 and the like used for storing the information (the number of combined packets and a size of each packet) required for the restoration process may be smaller than that of the configuration illustrated in FIG. 18, and therefore, the scale of required hardware can be reduced.

In addition, as a means for the packet combining unit 106 to notify the reception processing unit 103, the protocol processing unit 104, or the combined packet separating unit 108 illustrated in FIG. 18 of information required for the restoration process, the information required for the restoration process may be written inside a combined packet. More specifically, in order to notify of the size of each combined packet, for example, a method in which a header in which a packet size and the like are written is added before each packet, and the added header is written together with packet data may be considered. However, in this case, a part of the band of a bus used for the collected writing is occupied by the information required for the restoration process. Therefore, an effective band that can be used for writing the original packet data decreases, and, as a result, the performance of collected writing deteriorates.

In the packet processing device according to this embodiment, information required for the restoration process can be stored not in the packet memory 101 but in another memory (for which only writing from the packet combining unit 110 and reading from the combined packet transferring unit 113 may be able to be performed) not using the bus to which the packet memory 101 is connected, and thus, deterioration of the effective band as described above does not occur.

Similar to the first embodiment, as a modification of this embodiment, an area of a rewrite execution flag indicating whether a start address has been rewritten may be added to the descriptor 1130. In this case, when a start address inside the descriptor 1130 is rewritten in the process of Step S614 illustrated in FIG. 10, the combined packet transferring unit 113 may rewrite a corresponding rewrite execution flag inside the descriptor 1130 from the “rewriting non-executed” to “rewriting executed”.

In addition, similar to the first embodiment, in addition to the area of start addresses written by the transfer managing unit 112 (software executed by the processor), an area in which start addresses after change are written by the combined packet transferring unit 113 may be prepared in the descriptor 1130.

In addition, in this embodiment, the packet combining unit no may be configured to determine a type of packet and collect packets of the same type as a combined packet or may be configured to use a plurality of descriptors 1130 in accordance with a type of packet. When a configuration in which a descriptor 1130 is prepared for each type of packet, and a plurality of descriptors 1130 are used in accordance with the type of the packet, a different reception process may be easily performed for each type of packet.

In addition, in this embodiment, a configuration in which a plurality of descriptors 1130 are used for each core of the processor in which a plurality of CPU cores are built may be employed, or a configuration in which a plurality of descriptors 1130 are used for each virtual machine may be employed. By employing the configuration in which the plurality of descriptors 1130 are used for each CPU core or for each virtual machine, the performance of a reception process and a writing process implemented by software can be improved compared to a case in which there is only one descriptor 1130.

In the packet processing devices according to the first and second embodiments, the packet memory 101, the transfer managing unit 112, the reception processing unit 103, the protocol processing unit 104, and the combined packet transferring unit 113 may be realized by a computer including a processor, a storage device, and an interface and a program for controlling these hardware resources.

In such a computer, the program for realizing the packet processing method according to the present disclosure is stored in the storage device. The processor executes the processes described in the first and second embodiments in accordance with the program stored in the storage device. In addition, some processes of the combined packet transferring unit 111 may be realized by a computer.

### INDUSTRIAL APPLICABILITY

Embodiments of the present invention can be applied to technologies for performing protocol processing, a transfer process, and the like of communication data.

### REFERENCE SIGNS LIST

100 Line adapter
101 Packet memory
103 Reception processing unit
104 Protocol processing unit
105 Reception buffer
107 Combination threshold control unit
110 Packet combining unit
111, 113 Combined packet transferring unit
112 transfer managing unit
1110 1130 Descriptor
1111 DMA controller.

1.-6. (canceled)

7. A packet processing device comprising:
a line adapter configured to receive a plurality of packets from a communication line;
a packet combiner configured to generate a combined packet by combining the plurality of packets received from the communication line;
a packet memory configured to store packets received from the communication line; and
a combined packet transferor configured to:
direct memory access (DMA) transfer the combined packet to the packet memory or write the combined packet to the packet memory using a processor; and
write information of an address of each of the plurality of packets in the combined packet into a descriptor that is a data area of a memory, wherein the data area of the memory is set in advance.

8. The packet processing device according to claim 7, wherein the combined packet transferor is further configured to write a received data size indicating a packet length of each of the plurality of packets in the combined packet into the descriptor.

9. The packet processing device according to claim 7, further comprising one or more processors configured to:
read packets stored in the packet memory based on information written in the descriptor; and
perform processing of the packets read from the packet memory.

10. The packet processing device according to claim 7, wherein the packet combiner is configured to store the combined packet in a buffer until a size of the combined packet exceeds a threshold.

11. The packet processing device according to claim 10, wherein the packet combiner is further configured to in response to the size of the combined packet exceeding the threshold, request the combined packet transferor to send the combined packet to the packet memory.

12. The packet processing device according to claim 7, wherein the packet combiner is configured to:
store the combined packet in a buffer; and
in response to a timeout occurring, request the combined packet transferor to send the combined packet to the packet memory before a size of the combined packet exceeds a threshold.

13. A packet processing method comprising:
generating a combined packet by combining a plurality of packets received from a communication line;
direct memory access (DMA) transferring the combined packet to a packet memory or writing the combined packet to a packet memory, wherein the packet memory is read by a processor configured to perform processing of the plurality of packets received from the communication line; and
writing information of an address of first data of each of the plurality of packets in the combined packet into a descriptor that is a data area of a memory, wherein the data area of the memory is set in advance.

14. The packet processing method according to claim 13, further comprising writing information of a received data size indicating a packet length of each of the plurality of packets in the combined packet into the descriptor.

15. The packet processing method according to claim 13 further comprising:
reading packets from the packet memory based on information written in the descriptor; and
performing processing of the packets read from the packet memory.

16. The packet processing method of claim 13 further comprising storing the combined packet in a buffer until a size of the combined packet exceeds a threshold.

17. The packet processing method of claim 16 further comprising in response to the size of the combined packet exceeding the threshold, requesting that the combined packet be sent to the packet memory.

18. The packet processing method according to claim 13 further comprising:
storing the combined packet in a buffer; and
in response to a timeout occurring, requesting that the combined packet be sent to the packet memory before a size of the combined packet exceeds a threshold.
